(19) United States
(12) Patent Application Publication
(10) Pub. No.: US 2006/0056060 A1
(43) Pub. Date: Mar. 16, 2006

(54) Lens-barrel device

(76) Inventors: Masaaki Ozaki, Nara-shi (JP); Toshiyuki Tanaka, Osaka (JP)

Correspondence Address: EDWARDS & ANGELL, LLP, P.O. BOX 55874, BOSTON, MA, 02205, US

(21) Appl. No.: 11/208,037

(22) Filed: Aug. 18, 2005

(30) Foreign Application Priority Data
Aug. 26, 2004 (JP) P2004-246543

(51) Int. Cl. G02B 15/14

(52) U.S. Cl. 359/704

(57) ABSTRACT

A lens-barrel device has a movable lens-barrel 10 which holds an imaging lens group 11 and a fixed lens-barrel 20 into which the movable lens-barrel 10 is inserted so as to be movable in an axial direction. The movable lens-barrel 10 has a rear end part 10B including a tapered outer circumferential surface 31, and the fixed lens-barrel 20 has a front end part 20A including a tapered inner circumferential surface 22 that is engaged with the tapered outer circumferential surface 31 of the movable lens-barrel 10. A coiled spring 30 biases the movable lens-barrel 10 forward in the axial direction from the fixed lens-barrel 20. Radial impact forces can sufficiently be absorbed by the coiled spring 30 and by a tapered receiving structure composed of the tapered inner circumferential surface 22 and the tapered outer circumferential surface 31.

### CROSS-REFERENCE TO RELATED APPLICATIONS

This nonprovisional application claims priority under 35 U.S.C. 119(a) on basis of application No. 2004-246543 filed Aug. 26, 2004 in Japan. The disclosure thereof is incorporated herein by reference in its entirety.

### BACKGROUND OF THE INVENTION

The present invention relates to a lens-barrel device and, for example, relates to a lens-barrel device that is incorporated in a digital camera, a portable telephone including a camera or the like and that has a function of absorbing impact force in event of drop and a function of reducing vibration in imaging.

In recent years, collapsible lens-barrels that are drawn out from enclosure bodies on occasion of imaging have often been used as lens-barrels of small-size cameras such as compact digital still camera.

There is a problem in that a large impact force caused by drop or the like and exerted on such a lens-barrel protruded from an enclosure body may cause fracture in the lens-barrel or the like.

A prior art that solves the problem is disclosed in JP 2001-116974 A, for example.

As shown in FIG. 4A, a lens-barrel according to the prior art has a lens-barrel protecting member 103 surrounding a movable lens-barrel 101 and a buffer member 104 having a surface in contact with the lens-barrel protecting member 103. The buffer member 104 can be moved in directions of an optical axis relative to the movable lens-barrel 101. The lens-barrel protecting member 103 and the movable lens-barrel 101 have guide parts 101a and 103a. The guide parts 101a and 103a are intended for moving the buffer member 104 outside in a radial direction. Between the lens-barrel protecting member 103 and the movable lens-barrel 101 are placed buffer members 105.

When an external force is exerted on the lens-barrel protecting member 103 in a direction of optical axis, as shown by an arrow in FIG. 4B, the buffer members 105 are pressed by the lens-barrel protecting member 103. Besides, the buffer member 104 is pinched by the guide parts 101a, 103a from both sides in axial directions, is moved outside in the radial direction, and is then brought into contact with an inner circumferential surface of a fixed barrel 102. An impact force is thereby relaxed that is exerted on the movable lens-barrel 101 from the lens-barrel protecting member 103.

An example disclosed in JP 2000-266978 A has a plurality of holding members having elastic parts and being provided along a circumferential direction of a lens-barrel, and has a holding frame with which the elastic parts of the holding members are engaged. The example has a structure in which the lens-barrel is held with respect to the holding frame by the engagement of the elastic parts with the holding frame. The structure relaxes transmission of impact and vibration to the lens-barrel.

From a viewpoint of posture of the lens-barrel upon impact caused by drop, an impact force exerted on the lens-barrel is a resultant force of an impact force component parallel to a direction of an optical axis and an impact force component perpendicular to the direction of the optical axis.

The above-mentioned lens-barrel disclosed in JP 2001-116974 A exhibits impact resistance to the impact force against a front face in the direction of the optical axis but has a problem of weak impact resistance to the impact force component perpendicular to the direction of the optical axis.

The structure for holding the lens-barrel disclosed in JP 2000-266978 A exhibits impact resistance to the impact force component perpendicular to the direction of the optical axis but has a problem of weak impact resistance to the impact force component parallel to the direction of the optical axis.

Thus the prior arts described above have a problem in that failure to obtain sufficient impact resistance may cause damage to the lens-barrel depending upon posture of the lens-barrel at the instant of impact caused by drop.

### SUMMARY OF THE INVENTION

In consideration of the problems, an object of the present invention is to provide a lens-barrel device that is capable of improving impact resistance to impact forces exerted on a lens-barrel in both directions axial and perpendicular thereto and capable of preventing fracture in the lens-barrel.

In order to achieve the above object, there is provided a lens-barrel device comprising:
a first lens-barrel that holds lenses;
a second lens-barrel into which the first lens-barrel is inserted so as to be movable in an axial direction; and
a biasing part for biasing the first lens-barrel forward in the axial direction toward a subject from the second lens-barrel;
the first lens-barrel having a tapered outer circumferential surface;
the second lens-barrel having a tapered inner circumferential surface engaged with the tapered outer circumferential surface of the first lens-barrel.

In the lens-barrel device of the invention, the first lens-barrel is biased forward in the axial direction by the biasing part, and the tapered outer circumferential surface of the first lens-barrel is thereby brought into contact with the tapered inner circumferential surface of the second lens-barrel. When an impact force is exerted on the first lens-barrel in this situation, the tapered outer circumferential surface of the first lens-barrel slantly slides against a biasing force exerted by the biasing part (e.g., a coiled spring) while being in contact with the tapered inner circumferential surface of a front end part of the second lens-barrel and a component of the impact force that is perpendicular to the axial direction is thereby absorbed. On the other hand, a component of the impact force in the axial direction is relaxed by rearward movement of the first lens-barrel with respect to the axial direction against the biasing force exerted by the biasing part.

After the impact force disappears, the first lens-barrel is moved forward in the axial direction by the biasing force of the biasing part and the tapered outer circumferential surface is thereby brought into contact with the tapered inner circumferential surface of the second lens-barrel. Thus the first lens-barrel returns to an original position in which images can be captured.

In accordance with the invention, therefore, a lens-barrel device can be provided that is capable of improving impact resistance to impact forces exerted on the lens-barrel device in both directions axial and perpendicular thereto and capable of preventing fracture in the lens-barrel device.

In one embodiment of the present invention, the tapered outer circumferential surface is formed on a rear end part of the first lens-barrel and wherein the tapered inner circumferential surface is formed on a front end part of the second lens-barrel.

In accordance with the embodiment, a stroke of the axial movement of the first lens-barrel relative to the second lens-barrel can be maximized and a distance by which the first lens-barrel can axially be shifted on occasion of absorption of impact can be maximized. Accordingly, a large impact force can be coped with.

In one embodiment of the present invention, the lens-barrel device further comprises elastic members that are fixed to a front end part of the second lens-barrel and that are placed between the first lens-barrel and the second lens-barrel.

When the component of the impact force in the direction perpendicular to the axial direction is exerted on the first lens-barrel and the first lens-barrel is thereby moved in the direction perpendicular to the axial direction, in the embodiment, the elastic members are pressed by the first lens-barrel so as to undergo elastic compression. Thus impact resistance to the component of the impact force that is exerted in the direction perpendicular to the axial direction can further be improved.

In one embodiment of the present invention, the lens-barrel device further comprises a lens cover that is slidable relative to the first and second lens-barrels in a direction intersecting the axial direction and that is capable of taking a stored position in which front side of the first lens-barrel with respect to the axial direction has been covered with the lens cover with the first lens-barrel fit into the second lens-barrel rearward with respect to the axial direction and a photographing position in which the first lens-barrel has been protruded forward with respect to the axial direction from the second lens-barrel by a biasing force of the biasing part without the front side of the first lens-barrel being covered with the lens cover.

In accordance with the embodiment, when images are not captured, a front face of the first lens-barrel holding lenses can be protected by the lens cover brought to the storage position after the first lens-barrel is housed in the second lens-barrel. Thus impact resistance can further be improved.

In one embodiment of the present invention, the rear end part of the first lens-barrel has a yoke part embedded inside the tapered outer circumferential surface, and
wherein the front end part of the second lens-barrel has an electromagnetic coil unit embedded inside the tapered inner circumferential surface.

In accordance with the lens-barrel device of the embodiment, an attraction force is exerted between the yoke part embedded in the rear end part of the first lens-barrel and the electromagnetic coil by energizing when images are captured in the photographing position in which the first lens-barrel has been moved forward in the axial direction by the biasing force of the biasing part and in which the tapered outer circumferential surface of the rear end part of the first lens-barrel has been brought into contact with the tapered inner circumferential surface of the front end part of the second lens-barrel. Thus deflection of the optical axis that might be caused by vibrations can be prevented when images are captured. When images are not captured, on the other hand, maximal impact resistance can be attained by not energizing the electromagnetic coil.

In the lens-barrel device of the invention, the first lens-barrel is biased forward in the axial direction by the biasing part, and the tapered outer circumferential surface of the first lens-barrel is thereby brought into contact with the tapered inner circumferential surface of the second lens-barrel. When an impact force is exerted on the first lens-barrel in this situation, the tapered outer circumferential surface of the first lens-barrel slantly slides against a biasing force exerted by the biasing part (e.g., a coiled spring) while being in contact with the tapered inner circumferential surface of the second lens-barrel and the impact force component being perpendicular to the axial direction is thereby relaxed. On the other hand, the impact force component in the axial direction is relaxed by axially rearward movement of the first lens-barrel against the biasing force exerted by the biasing part.

In accordance with the lens-barrel device of the invention, therefore, impact resistance against impact forces exerted on the lens-barrel device in both the directions axial and perpendicular thereto can be improved and fracture in the lens-barrel device can be prevented.

### BRIEF DESCRIPTION OF THE DRAWINGS

The present invention will be understood more fully from the following detailed description and the accompanying drawings. The detailed description and the drawings are given only as an illustration and do not limit the invention.

FIG. 1A is a sectional view showing main parts of a camera module having a first embodiment of lens-barrel device of the invention in a state in which impact has not been applied;

FIG. 1B is a sectional view showing the main parts of the camera module in a state in which impact has been applied;

FIG. 2A is a sectional view showing main parts of a camera module having a second embodiment of lens-barrel device of the invention (in stored state);

FIG. 2B is a sectional view showing the main parts of the camera module (in photographing state);

FIG. 3 is a sectional view showing main parts of a camera module having a third embodiment of lens-barrel device of the invention;

FIG. 4A is a diagram showing a section of main parts of a conventional lens-barrel device; and

FIG. 4B is a diagram showing the conventional lens-barrel device on which an external force is being exerted.

### DETAILED DESCRIPTION OF THE INVENTION

Hereinbelow, the present invention will be described in detail with reference to embodiments shown in the accompanying drawings.

### First Embodiment

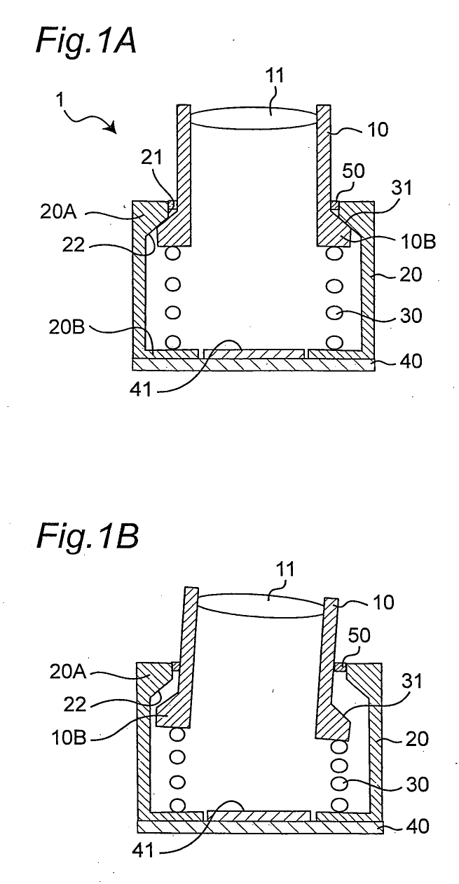

FIGS. 1A and 1B show sections of main parts of a camera module having a lens-barrel device 1 in accordance with a first embodiment of the invention, the sections taken along a plane including an optical axis. FIG. 1A is a section of the lens-barrel device 1 to which no impact has been applied, and FIG. 1B is a section of the lens-barrel device 1 to which impact has been applied.

As shown in FIG. 1A, the lens-barrel device 1 in accordance with the first embodiment has a movable lens-barrel 10 as a first lens-barrel that holds an imaging lens group 11, a fixed lens-barrel 20 as a second lens-barrel, and a coiled spring 30 that biases the movable lens-barrel 10 forward in an axial direction pointing to a subject.

The lens-barrel device 1 has elastic members 50, which are fixed to an inner circumferential surface 21 of a front end part 20A of the fixed lens-barrel 20. The elastic members 50 are placed between an outer circumferential surface of the movable lens-barrel 10 and the inner circumferential surface of the fixed lens-barrel 20, and face the outer circumferential surface of the movable lens-barrel 10. The elastic members 50 may be a single ring-like member or may be a plurality of members placed along the circumferential direction. The elastic members 50 are composed of elastic material such as foam rubber and urethane foam, for example. Surfaces of the elastic members 50 in contact with the fixed lens-barrel 20 have been fixed and held to the fixed lens-barrel 20, and surfaces thereof in contact with the movable lens-barrel 10 have undergone surface treatment for satisfactory slidability.

The coiled spring 30 is placed between a bottom part 20B of the fixed lens-barrel 20 and a rear end part 10B of the movable lens-barrel 10. One end of the coiled spring 30 is fixed in contact with an inner surface of the bottom part 20B of the fixed lens-barrel 20, and the other end thereof is fixed in contact with a bottom surface of the rear end part 10B. As shown in FIG. 1A, the rear end part 10B of the movable lens-barrel 10 has a tapered outer circumferential surface 31, which is engaged with a tapered inner circumferential surface 22 of the front end part 20A of the fixed lens-barrel 20.

The bottom part 20B of the fixed lens-barrel 20 is mounted on a circuit board 40, which has a solid-state image sensing device 41 such as CCD mounted on the circuit board 40. The solid-state image sensing device 41 is placed in an opening of the bottom part 20B. The lens-barrel device 1 and the circuit board 40 constitute the main parts of the camera module.

FIG. 1B shows the section of the lens-barrel device 1 having the above configuration in which an impact force has been applied to the movable lens-barrel 10 from front slantly to the axial direction. A component of the impact force parallel to the axial direction is absorbed by elastic deformation of the coiled spring 30 in the axial direction.

On the other hand, a component of the impact force perpendicular to the axial direction is absorbed by a slant slide of the tapered outer circumferential surface 31 of the rear end part 10B of the movable lens-barrel 10 along the tapered inner circumferential surface 22 of the front end part 20A of the fixed lens-barrel 20 and by elastic deformation of the elastic members 50.

The above actions sufficiently absorb the components of the impact force that are applied to the movable lens-barrel 10 and that are parallel to and perpendicular to the axial direction, and protect the movable lens-barrel 10. After the impact forte disappears, the tapered outer circumferential surface 31 of the rear end part 10B of the movable lens-barrel 10 can be returned to an original position, i.e. an initial state, shown in FIG. 1A by a biasing force of the coiled spring 30 while the surface 31 is guided by the tapered inner circumferential surface 22 of the front end part 20A of the fixed lens-barrel 20.

### Second Embodiment

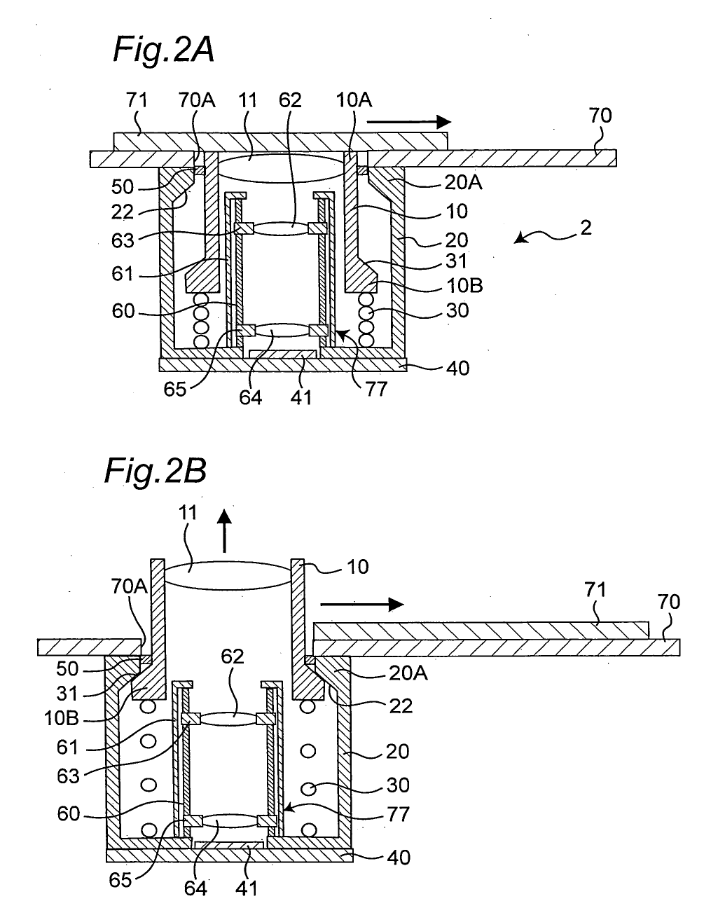

FIGS. 2A and 2B show sections of a camera module having a second embodiment of lens-barrel device of the invention, the sections taken along a plane including an optical axis. The camera module has optical zoom function and is incorporated in an enclosure 70. The enclosure 70 is, for example, an enclosure of portable information equipment such as portable telephone including camera and digital still camera.

As shown in FIG. 2A, the lens-barrel device of the second embodiment differs from the first embodiment described above, in that a zoom lens unit 77 and a lens cover 71 are added to the lens-barrel device of the first embodiment. Accordingly, the second embodiment will be described mainly on the difference from the first embodiment.

In the lens-barrel device 2 of the second embodiment, a front end part 20A of a fixed lens-barrel 20 is fixed to an inner circumferential surface of an enclosure 70. A movable lens-barrel 10 is placed so as to slide in axial directions inside an opening 70A of the enclosure 70.

The zoom lens unit 77 has a magnification-variable lens group 62 and a focusing lens group 64 that reside in front of a solid-state image sensing device 41 in the axial direction and that face up to the solid-state image sensing device 41. The lens groups 62 and 64 are held by lens frames 63 and 65, respectively, and the lens frames 63 and 65 are axially slidable along linear guide shafts 60 extending axially. The linear guide shafts 60 are placed inside and supported by a supporting member 61. The lens groups 62 and 64 can be moved in directions of the optical axis along the linear guide shafts 60 by driving forces not shown.

In the stored state of the lens-barrel device of the embodiment shown in FIG. 2A, the movable lens-barrel 10 has been fitted in rearward with respect to the axial direction and has been housed in the fixed lens-barrel 20, so that a coiled spring 30 has undergone elastic deformation between a rear end part 10B of the movable lens-barrel 10 and the fixed lens-barrel 20. In the stored state, the lens cover 71 has covered the opening 70A of the enclosure 70, and a front end part 10A of the movable lens-barrel 10 has pressed a rear face of the lens cover 71 by action of a biasing force exerted by the coiled spring 30.

When the lens cover 71 is slid to an photographing position in a direction of an arrow shown in FIG. 2A (the direction orthogonal to the axial direction), the lens cover 71 fully opens the opening 70A of the enclosure 70 and the front end part 10A of the movable lens-barrel 10 is protruded forward with respect to the axial direction through the opening 70A by action of the coiled spring 30, as shown in photographing state of FIG. 2B. In the photographing state, a tapered outer circumferential surface 31 of the rear end part 10B of the movable lens-barrel 10 is engaged with a tapered inner circumferential surface 22 of the front end part 20A of the fixed lens-barrel 20.

In accordance with the lens-barrel device of the embodiment, the movable lens-barrel 10 is moved forward with respect to the axial direction with use of the biasing force exerted by the coiled spring 30, and therefore electric power can be saved when the movable lens-barrel 10 is drawn out to photographing stand-by state. Furthermore, the lens cover 71 covers the front end part 10A of the movable lens-barrel 10 in the stored state shown in FIG. 2A, and thus impact resistance in the stored state can be improved.

It goes without saying that radial impact forces can sufficiently be absorbed by the coiled spring 30, by a tapered receiving structure composed of the tapered inner circumferential surface 22 and the tapered outer circumferential surface 31, and by the elastic members 50, in the photographing state shown in FIG. 2B, in the second embodiment as is the case with the first embodiment described above.

### Third Embodiment

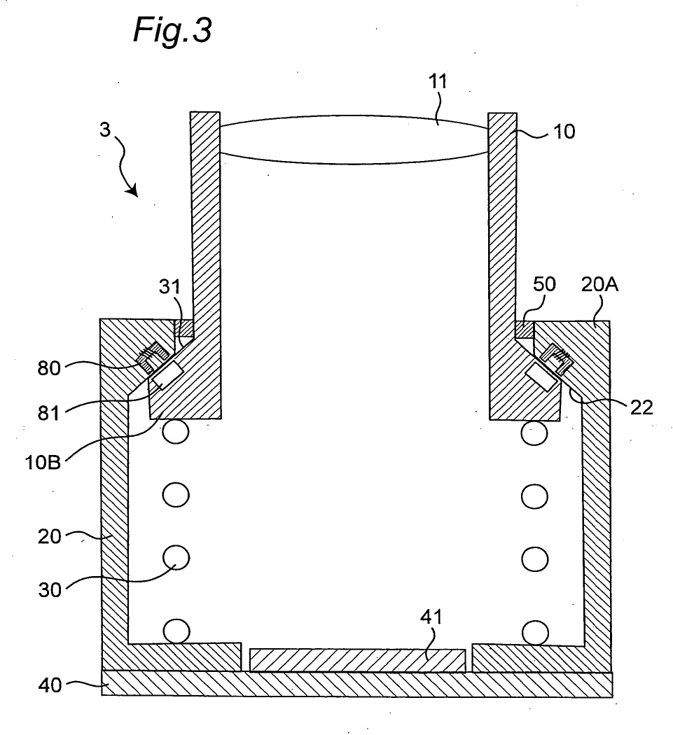

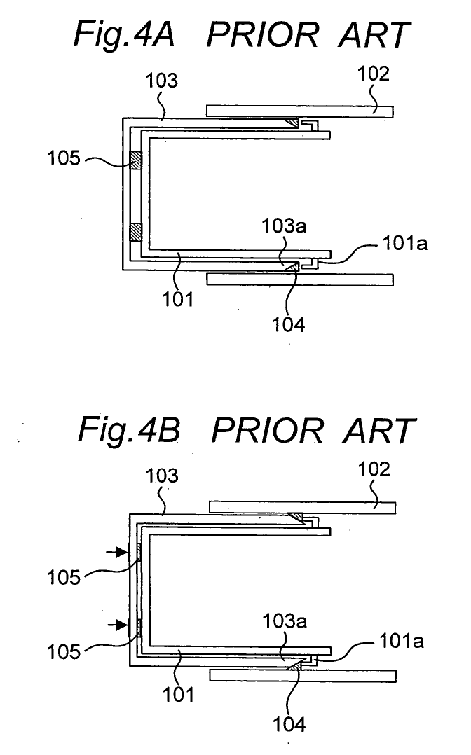

FIG. 3 shows a section of main parts of a camera module having a lens-barrel device 3 of a third embodiment of the invention, the section taken along a plane including an optical axis. The third embodiment, which is a modification of the first embodiment, will be described mainly on differences from the first embodiment.

The third embodiment has an electromagnetic coil unit 80 embedded in a front end part 20A of a fixed lens-barrel 20 and a yoke member 81 embedded in a rear end part 10B of a movable lens-barrel 10. The electromagnetic coil unit 80 is made of U-shaped magnetic material wound with winding coil.

In a state in which a tapered inner circumferential surface 22 of the front end part 20A is engaged with a tapered outer circumferential surface 31 of the rear end part 10B, as shown in FIG. 3, the electromagnetic coil unit 80 and the yoke member 81 face each other with a specified gap therebetween.

A magnetic attraction force between the electromagnetic coil unit 80 and the yoke member 81 is controlled by a current flowing through the winding coil controlled by a current controlling circuit not shown. Thus an attractive force can be controlled between the tapered outer circumferential surface 31 of the movable lens-barrel 10 and the tapered inner circumferential surface 22 of the fixed lens-barrel 20.

When a shutter is released and a picture is taken in a camera in which the camera module is incorporated, for example, the magnetic attraction force is exerted, in addition to a biasing force of the coiled spring 30, by the current flowing through the winding coil of the electromagnetic coil unit 80. Thus a connecting force between the movable lens-barrel 10 and the fixed lens-barrel 20 can be increased, and deflection of the optical axis of the movable lens-barrel 10 caused by vibrations applied from outside can be restrained.

When the camera module is not in photographing stand-by state, the winding coil is not energized. Thus the connecting force between the movable lens-barrel 10 and the fixed lens-barrel 20 can be generated only by the biasing force of the coiled spring 30 so that resistance to drop impact can be ensured.

In this manner, provision of the electromagnetic coil unit 80 makes it possible to control the connecting force between the movable lens-barrel 10 and the fixed lens-barrel 20 and therefore makes it possible to widen a choice of spring constant of the coiled spring in view of prioritizing the resistance to drop impact.

In accordance with the lens-barrel device of the third embodiment also, impact resistance to both an impact force in a direction of the optical axis and perpendicular thereto can be improved by the coiled spring 30, by a tapered receiving structure composed of the tapered inner circumferential surface 22 and the tapered outer circumferential surface 31, and by elastic members 50, as is the case with the first embodiment described above. Accordingly, radial impact forces can sufficiently be absorbed and fracture in the lens-barrels can be prevented.

Though the invention has been described as above, it is apparent that the invention can be changed in various manners. It is to be understood that such changes are not regarded as departures from the spirit and the scope of the invention and that all modifications obvious to those skilled in the art are embraced by the appended claims.

What is claimed is:

1. A lens-barrel device comprising:
a first lens-barrel that holds lenses;
a second lens-barrel into which the first lens-barrel is inserted so as to be movable in an axial direction; and
a biasing part for biasing the first lens-barrel forward in the axial direction toward a subject from the second lens-barrel;
the first lens-barrel having a tapered outer circumferential surface;
the second lens-barrel having a tapered inner circumferential surface engaged with the tapered outer circumferential surface of the first lens-barrel.

2. A lens-barrel device as claimed in claim 1, wherein the tapered outer circumferential surface is formed on a rear end part of the first lens-barrel and wherein the tapered inner circumferential surface is formed on a front end part of the second lens-barrel.

3. A lens-barrel device as claimed in claim 2, further comprising elastic members that are fixed to a front end part of the second lens-barrel and that are placed between the first lens-barrel and the second lens-barrel.

4. A lens-barrel device as Claimed in claim 1, further comprising a lens cover that is slidable relative to the first and second lens-barrels in a direction intersecting the axial direction and that is capable of taking a stored position in which front side of the first lens-barrel with respect to the axial direction has been covered with the lens cover with the first lens-barrel fit into the second lens-barrel rearward with respect to the axial direction and a photographing position in which the first lens-barrel has been protruded forward with respect to the axial direction from the second lens-barrel by a biasing force of the biasing part without the front side of the first lens-barrel being covered with the lens cover.

5. A lens-barrel device as claimed in claim 2,
wherein the rear end part of the first lens-barrel has a yoke part embedded inside the tapered outer circumferential surface, and
wherein the front end part of the second lens-barrel has an electromagnetic coil unit embedded inside the tapered inner circumferential surface.
